(19) United States
(12) Patent Application Publication
(10) Pub. No.: US 2023/0319587 A1
(43) Pub. Date: Oct. 5, 2023

(54) STAND ALONE BROADBAND FOR RURAL ENVIRONMENT

(71) Applicant: Roel Willem Coert, Lions Bay (CA)

(72) Inventor: Roel Willem Coert, Lions Bay (CA)

(21) Appl. No.: 17/712,158

(22) Filed: Apr. 3, 2022

(51) Int. Cl. H04W 16/24

(52) U.S. Cl. CPC H04W 16/24

(57) ABSTRACT

A system and method for providing internet to a rural environment is disclosed. The system includes a housing, such as a shipping container, having means for connecting the system to the internet and means for outputting an internet signal to the rural environment. For example, in some embodiments the system utilizes satellite, fiber optics, point to point wireless, television white space, cellular and/or WIFI to facilitate the receipt and transmission of data between a plurality of client terminals in the rural environment and the internet.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of internet access of existing art and more specifically relates to a system and method for providing high speed internet to a rural environment.

### RELATED ART

The internet is defined as a global computer network providing a variety of information and communication facilities, consisting of interconnected networks using standardized communication protocols. The internet is arguably the greatest invention of the 20th century; it impacted humanity in many ways, providing users all over the world with a means of communicating, working, learning, etc.

Typically, an internet service provider delivers internet signals to an environment via wireless and/or wired means—for example, satellite internet, fiber optic cables, or the like—to enable users to access the internet. However, rural areas around the world still struggle to receive internet connection, especially high speed internet connection. This is often due to an inability and/or impracticality for an internet service provider to run fiber optic cables to the area and/or due to the rural areas being out of line-of-sight of antennas or otherwise unable to adequately receive and/or transmit radio waves. As such, a suitable solution is desired.

### SUMMARY OF THE INVENTION

In view of the foregoing disadvantages inherent in the known internet connection art, the present disclosure provides standalone broadband for a rural environment. The general purpose of the present disclosure, which will be described subsequently in greater detail, is to provide a system for providing high speed internet to a rural environment via various means being strategically installed within the rural environment.

A system for providing internet to a rural environment is disclosed herein. The system may include a housing, a means for connecting the system to the internet and a means for outputting an internet signal to the rural environment. The housing may be installed strategically within the rural environment. The means for connecting the system to the internet may be disposed about the housing and may include at least one first wired assembly and at least one first wireless assembly. The means for outputting an internet signal to the rural environment may be disposed about the housing and may include at least one second wireless assembly. The system may enable a plurality of client terminals within the rural environment to connect to the internet, thereby facilitating receipt and transmission of data between the plurality of client terminals and the internet.

According to another embodiment, a method for providing internet to a rural environment is also disclosed herein. The method may include the steps of: providing the system as above; strategically installing the housing within the rural environment; connecting the system to the internet via at least one of the at least one first wired assembly and the at least one first wireless assembly; outputting the internet signal to the rural environment via the at least one second wireless assembly thereby enabling connection of a plurality of client terminals within the rural environment to the internet; and facilitating receipt and transmission of data between the plurality of client terminals and the internet.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, standalone broadband for a rural environment, constructed and operative according to the teachings of the present disclosure.

FIG. 1 is a schematic diagram of a system for providing internet to a rural environment, according to an embodiment of the disclosure.

FIG. 2 is a schematic diagram of the system including a broadband telecommunication node, at least one first wireless assembly, at least one second wireless assembly, at least one first wired assembly, and at least one second wired assembly, according to an embodiment of the disclosure.

FIG. 3 is a perspective view of the system including a shipping container, a mast having a plurality of antennas thereon, and a solar array according to an embodiment of the present disclosure.

FIG. 4 is a partial schematic diagram of the system being used to provide the internet to the rural environment according to an embodiment of the present disclosure.

FIG. 5 is a flow diagram illustrating a method of providing internet to a rural environment, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to high speed internet access and more particularly to stand alone broadband for a rural environment. Generally, a system and method are provided to provide high speed internet to end-user premises in underserved telecommunication areas by combining technologies and services. For example, the system and method may utilize technology and services based on IEEE 802.11af, IEEE 802.22, future standards (such as television white space), Wireless Point to Point, fiber optic cables and/or satellite internet to backhaul data to the internet. The technology and services may be installed atop and within a standard shipping container which may be strategically installed within the rural environment.

The system may include a broadband telecommunication node and power equipment housed in the shipping container. In some embodiments, the shipping container may be reinforced to support a 12-30 meter (in height) guyed or no guyed collapsing mast. In other embodiments, the mast may be installed adjacent to the shipping container. The broadband telecommunication node may include technology for backhauling data to the internet, through (but not limited to) satellite, fiber optic cables, point to point wireless and/or a combination of these (or other) technologies. Further, broadband telecommunication node may include technology for providing end user connection to the broadband telecommunication node through (but not limited to) television white space technology, WIFI, point to point wireless, Long Term Evolution cellular wireless and/or fiber optic cables.

The system may be connected to an existing power grid and/or may include a power supply based on renewable and non-renewable technologies. For example, the system may include a solar array, wind turbines and/or electric generators. The broadband telecommunication node may include all technologies needed to operate in any habituated terrestrial climate environment.

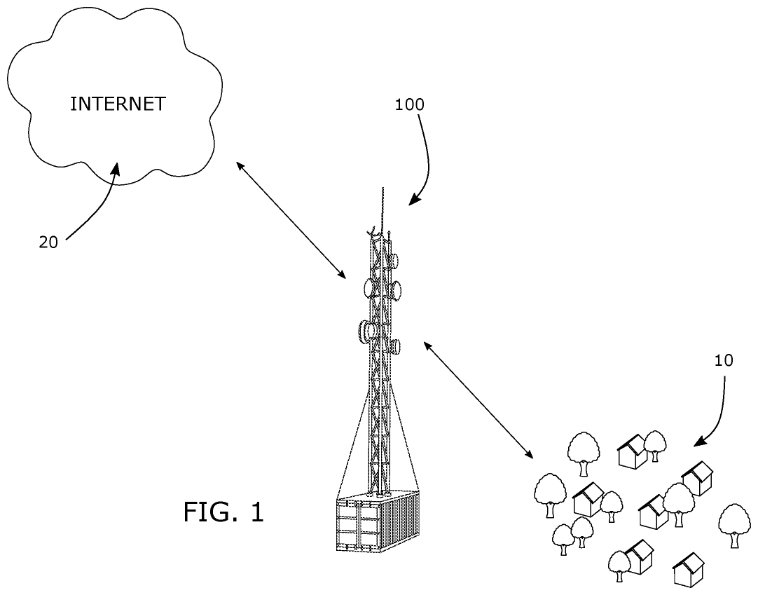

Referring now more specifically to the drawings by numerals of reference, there is shown in FIGS. 1-4, various views of a system 100. The system 100 may provide internet 20 (via signals) to a rural environment 10. Specifically, the system 100 may include a housing 110, a means for connecting the system to the internet and a means for outputting an internet signal to the rural environment, such that users within the rural environment 10 may connect to the internet 20, via the system 100.

The system 100 may enable a plurality of client terminals 30 within the rural environment 10 to connect to the internet 20, thereby facilitating receipt and transmission of data between the plurality of client terminals 30 and the internet 20. The plurality of client terminals 30 may include a plurality of electronic devices per building/residence (such as laptop computers, desktop computers, smartphones, tablet computers, or the like), individual devices that are near to the system (such as smartphone users) etc. As such, the housing 110 may be installed strategically within the rural environment 10. For example, the housing 110 may be installed in an area with optic fiber access, at a location able to better receive wireless communications, at a particular distance away from the rural environment, etc.

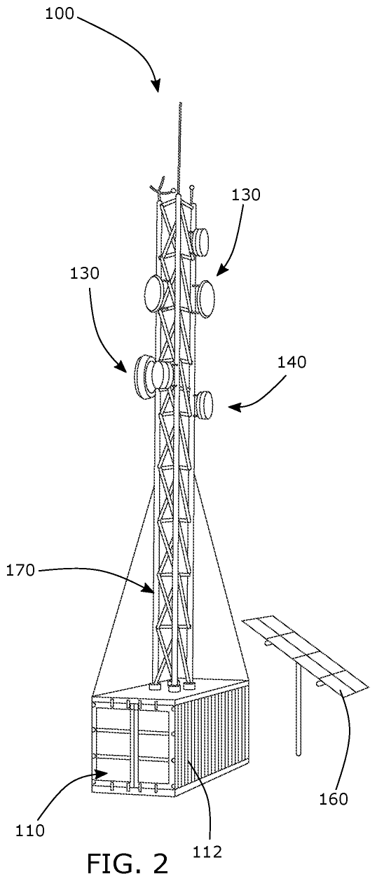

As shown, preferably, the housing 110 may be a shipping container 112. This may enable the system 100 to be reasonably inexpensive to assemble and install. The shipping container 112 may preferably be reinforced in order to support elements needed for the system 100. For example, as shown, a guyed mast 170 that supports antenna(s), power suppliers, or the like may be attached atop the shipping container 112. In some embodiments, the system 100 may be configured to connect to an existing power grid supplying power to the rural environment 10. Additionally, or instead of this, the system 100 may include at least one power supply. Preferably, in this embodiment, the at least one power supply may include at least one renewable power supply. For example, as shown in FIG. 2, a solar array 160 may be included with the system 100 and located proximate the housing 110 to supply power thereto.

Elements of the means for connecting the system to the internet and the means for outputting an internet signal to the rural environment may be combined into, integral to and/or configured to communicate with a broadband telecommunication node 114. For example, the broadband telecommunication node 114 may include at least one modem, at least one router, at least one access point, at least one multiplexer, and/or the like configured to receive, transmit and route the data between the plurality of client terminals 30 and the internet 20. Each client terminal 30 may receive the internet signal via antennas, receivers, modems, etc. For example, in some embodiments, antennas located on houses in the rural environment may receive the internet signal. In another example, receivers/antennas integral to a user's electronic device (such as a smartphone) may receive the internet signal. Additionally, in some embodiments, the plurality of client terminals 30 may receive the internet signal via fiber optic cables.

Further, in some embodiments, the means for connecting the system to the internet and the means for outputting an internet signal to the rural environment may be attached about the housing 110. Preferably, the means for connecting the system to the internet may include at least one first wired assembly 120 and at least one first wireless assembly 130; and the means for outputting an internet signal to the rural environment may include at least one second wireless assembly 140. In some embodiments, the means for connecting the system to the internet 20 may connect directly to an internet backbone. In other embodiments, the means for connecting the system to the internet 20 may receive internet signals from one or more internet service providers.

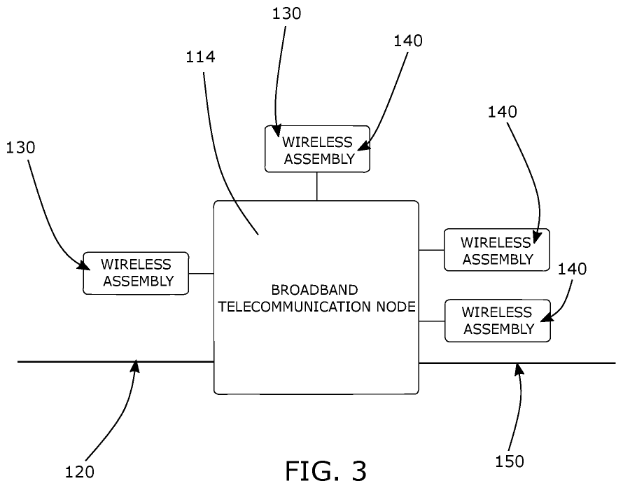

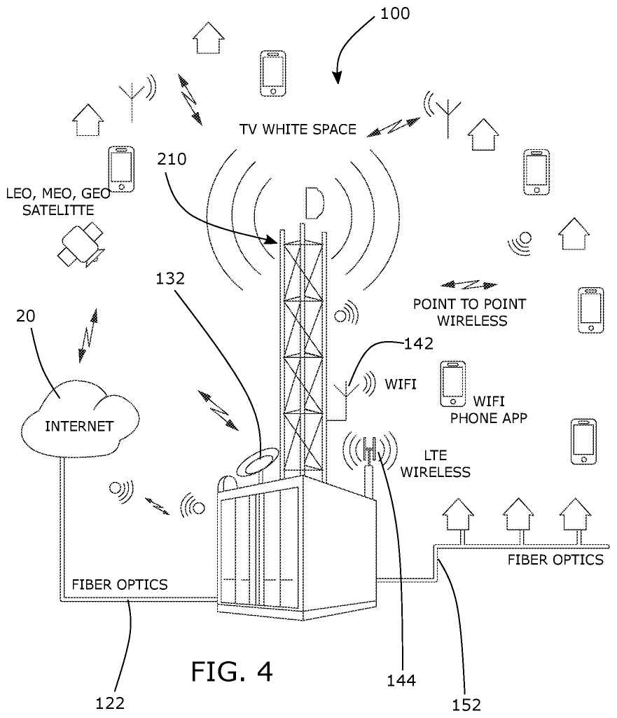

In some embodiments, as shown in FIGS. 3-4, the at least one first wired assembly 120 may include a first fiber optic cable 122. As discussed above, the housing 110 may be strategically installed within the rural environment 10. In this example, the first fiber optic cable 122 may be an existing fiber optic cable, and the housing 110 may installed at a location proximate to the existing fiber optic cable so as to connect with the first fiber optic cable 122 and receive internet signals therefrom.

As shown in FIGS. 2-4, the at least one first wireless assembly 130 may include at least one antenna 210. Further, the at least one second wireless assembly also may include the at least one antenna 210. The at least one antenna 210 may be configured to receive and transmit the data via radio waves. As shown and as discussed above, the system 100 may include the guyed mast 170 attached atop the housing 110 and the at least one antenna 210 may be attached about the guyed mast 170. This may enable the at least one antenna 210 to better receive and transmit the radio waves.

Further, as shown in FIGS. 2-4, the at least one first wireless assembly 130 may further include at least one satellite antenna 132. As shown, the at least one satellite antenna 132 may also be attached to the guyed mast 170. The at least one antenna 210 and the at least one satellite antenna 132 may provide internet (via signals) to the system 100 as well as backhauling of data to the internet 20 from the plurality of users via satellite technology and/or point to point wireless technology. Further, the existing fiber optic cables may provide internet to the system 100 as well as backhauling of data to the internet 20.

In some embodiments, the at least one antenna 210 may provide the internet signal by using TV white space (unused radio frequencies allocated to a broadcasting service) based on IEEE 802.11af, IEEE 802.22 and/or future standards. The system 100 may utilize the television white space operating between 470-790 MHz, allowing the at least one antenna to propagate radio waves to and from areas that are not in line-of-sight for the at least one antenna 210, providing stronger internet signal to more users in the rural environment 10.

As shown in FIGS. 2-4, in some embodiments, the at least one second wireless assembly 140 may further include at least one WIFI antenna 142. As such, the system 100 may enable connection to the internet 20 via WIFI. As shown, the WIFI antenna 142 may also be attached to the guyed mast 170. Further, the at least one second wireless assembly 140 may include at least one cellular network antenna 144. In this example, the internet signal may be provided to the rural environment 10 via the at least one cellular network antenna 144. As shown, the at least one cellular network antenna 144 may be attached to the guyed mast 170. In some embodiments, the at least one cellular network antenna 144 may operate based on long term evolution (LTE) standard (but is not limited to this standard). In some embodiments, the means for outputting an internet signal to the rural environment 10 may further include at least one second wired assembly 150. As shown in FIGS. 3-4, the at least one second wired assembly 150 may include a second fiber optic cable 152.

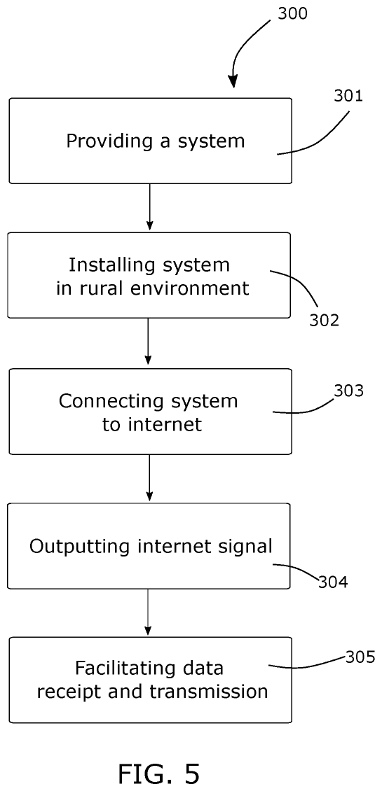

Referring now to FIG. 5 showing a flow diagram illustrating a method 300 for providing internet to a rural environment, according to an embodiment of the present disclosure. In particular, the method 300 may include one or more components or features of the system 100 as described above. As illustrated, the method 300 may include the steps of: step 301, providing the system as above; step 302, strategically installing the housing within the rural environment; step 303, connecting the system to the internet via at least one of the at least one first wired assembly and at least one first wireless assembly; step 304, outputting the internet signal to the rural environment via the at least one second wireless assembly thereby enabling connection of a plurality of client terminals within the rural environment to the internet; and step five 305, facilitating receipt and transmission of data between the plurality of client terminals and the internet. Further, as discussed above, the internet signal may also be output via the at least one second wired assembly (such as fiber optic cable).

It should be noted that certain steps may be optional and may not be implemented in all cases. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for providing internet to a rural environment are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A system for providing internet to a rural environment, the system comprising:
a housing strategically installed within the rural environment;
a means for connecting the system to the internet, the means disposed about the housing, the means including at least one first wired assembly and at least one first wireless assembly; and
a means for outputting an internet signal to the rural environment, the means disposed about the housing, the means including at least one second wireless assembly;
wherein the system enables a plurality of client terminals within the rural environment to connect to the internet and thereby facilitates receipt and transmission of data between the plurality of client terminals and the internet.

2. The system of claim 1, wherein the housing includes a shipping container.

3. The system of claim 2, wherein the at least one first wired assembly includes a first fiber optic cable.

4. The system of claim 3, wherein the at least one first wireless assembly includes at least one antenna, and wherein the at least one second wireless assembly includes the at least one antenna.

5. The system of claim 4, wherein the at least one first wireless assembly further includes at least one satellite antenna.

6. The system of claim 5, wherein the at least one second wireless assembly further includes at least one of at least one WIFI antenna and at least one cellular network antenna.

7. The system of claim 6, wherein the means for outputting an internet signal to the rural environment further includes at least one second wired assembly.

8. The system of claim 7, wherein the at least one second wired assembly includes a second fiber optic cable.

9. The system of claim 1, further comprising a solar array located proximate the housing and configured to supply power thereto.

10. A method for providing internet to a rural environment, the method comprising:
providing a system including:
a housing;
a means for connecting the system to the internet, the means disposed about the housing, the means including at least one first wired assembly and at least one first wireless assembly; and
a means for outputting an internet signal to the rural environment, the means disposed about the housing, the means including at least one second wireless assembly;
strategically installing the housing within the rural environment;
connecting the system to the internet via at least one of the at least one first wired assembly and the at least one first wireless assembly;
outputting the internet signal to the rural environment via the at least one second wireless assembly, thereby enabling connection of a plurality of client terminals within the rural environment to the internet; and
facilitating receipt and transmission of data between the plurality of client terminals and the internet.

11. The method of claim 10, wherein the housing includes a shipping container.

12. The method of claim 11, wherein the at least one first wired assembly includes a first fiber optic cable.

13. The method of claim 12, wherein the at least one first wireless assembly includes at least one antenna, and wherein the at least one second wireless assembly includes the at least one antenna.

14. The method of claim 13, wherein the at least one first wireless assembly further includes at least one satellite antenna.

15. The method of claim 14, wherein the at least one second wireless assembly further includes at least one of at least one WIFI antenna and at least one cellular network antenna.

16. The method of claim 15, wherein the means for outputting an internet signal to the rural environment further includes at least one second wired assembly.

17. The method of claim 16, wherein the at least one second wired assembly includes a second fiber optic cable.

18. The method of claim 10, further comprising a solar array located proximate the housing and configured to supply power thereto.

19. A system for providing internet to a rural environment, the system comprising:
a shipping container strategically installed within the rural environment;
a means for connecting the system to the internet, the means disposed about the housing, the means including at least one first wired assembly and at least one first wireless assembly, the at least one first wired assembly including a first fiber optic cable, the at least one first wireless assembly including at least one of at least one antenna and at least one satellite antenna; and
a means for outputting an internet signal to the rural environment, the means disposed about the housing, the means including at least one second wireless assembly and at least one at least one second wired assembly, the at least one second wireless assembly including the at least one antenna and at least one of at least one WIFI antenna and at least one cellular network antenna, the at least one second wired assembly including a second fiber optic cable;
wherein the system enables a plurality of client terminals within the rural environment to connect to the internet and thereby facilitates receipt and transmission of data between the plurality of client terminals and the internet.

20. The system of claim 19, further comprising a solar array located proximate the shipping container and configured to supply power thereto.
